(19) United States
(12) Patent Application Publication
(10) Pub. No.: US 2026/0290913 A1
(43) Pub. Date: Sep. 24, 2026

(54) BATTERY CELL

(71) Applicant: HONDA MOTOR CO., LTD., Tokyo (JP)

(72) Inventors: Kazushige Iwasaki, Wako-shi (JP); Taiga Hashi, Wako-shi (JP); Shigeru Koyama, Wako-shi (JP)

(21) Appl. No.: 19/541,707

(22) Filed: Feb. 17, 2026

(30) Foreign Application Priority Data
Mar. 24, 2025 (JP) 2025-048202

(51) Int. Cl. H01M 10/42; H01M 10/0525; H01M 50/105; H01M 50/209; H01M 50/211; H01M 50/528; H01M 50/534

(52) U.S. Cl. CPC H01M 10/425; H01M 10/0525; H01M 50/105; H01M 50/209; H01M 50/211; H01M 50/528; H01M 50/534

(57) ABSTRACT

A battery cell 1 includes a positive electrode tab 3 and a negative electrode tab, which are provided on a short side 1b; a positive electrode holding member 5 and a negative electrode holding member, which respectively hold the positive electrode tab 3 and the negative electrode tab; an exterior body 7 made of laminate films, which has a folded part on a long side 1a; and a frame unit 8 disposed on the long side 1a and connected to the positive electrode holding member 5 and the negative electrode holding member. The folded part has a protruding portion that protrudes in a surface direction (Z direction) of the exterior body 7. The frame unit 8 is composed of at least two parts and is disposed on both sides of the protruding portion in a thickness direction (X direction) of the exterior body 7.

### CROSS-REFERENCE TO RELATED APPLICATION

Priority is claimed on Japanese Patent Application No. 2025-048202, filed Mar. 24, 2025, the content of which is incorporated herein by reference.

### BACKGROUND OF THE INVENTION

### Field of the Invention

The present invention relates to a battery cell.

### Description of Related Art

In recent years, in order to ensure more people have access to affordable, reliable, sustainable, and advanced energy, research and development have been carried out on energy efficient batteries.

For example, a battery cell in which an electrode body is covered with an exterior body made of a laminate film is known (see, for example, Patent Document 1 (Japanese Unexamined Patent Application, First Publication No. 2022-14715)).

### SUMMARY OF THE INVENTION

By the way, in technology relating to battery cells, it is generally difficult to protect an electrode body from an external force with an exterior body made of a laminate film in a case where an external force is applied to the battery cell. In order to protect the electrode body from an external force, for example, it is necessary to attach a frame to an exterior body. However, in a case of attaching a frame to an exterior body, there are no parts to be attached thereto in a case of mounting the frame in the battery cell.

In order to solve the above problems, an object of the present invention aims to protect an electrode body from external forces. In addition, the present invention consequently contributes to improving energy efficiency.

In order to solve the above problems, the present invention proposes the following.
(1) A battery cell according to the present invention has a substantially rectangular shape, the battery cell including a tab provided on a short side thereof, a holding member that holds the tab, an exterior body made of a laminate film having a folded part on at least one long side thereof, and a frame disposed on the long side and connected to the holding member, in which the folded part includes a protruding portion that protrudes in a surface direction of the exterior body, and the frame is composed of at least two parts and is disposed on both sides of the protruding portion in a thickness direction of the exterior body.

According to the aspect (1), a frame is provided on the long side of the battery cell, and the frame is connected to the holding member. In addition, a folded part of the exterior body is provided on the long side of the battery cell, and a protruding portion provided in the folded part protrudes in the surface direction of the exterior body. Further, a frame is disposed on both sides of the protruding portion that has protruded.

In this way, by connecting the frame provided on the long side of the battery cell to the holding member and disposing it on both sides of the protruding portion, the frame can be attached to the exterior body or the holding member in an integrated structure. As a result, in a case where an external force is applied to the battery cell, the external force can be reduced by the frame. This makes it possible to protect the electrode body sealed inside the exterior body from external forces.

In addition, the frame is disposed on both sides of the protruding portion. As a result, it is possible to prevent the frame from protruding from the protruding portion in the surface direction of the exterior body.
(2) In the above aspect (1), both end portions of the holding member may have an opening portion that houses an end portion of the frame.

According to the aspect (2), the holding member has an opening portion at both end portions, and the end portion of the frame is housed in the opening portion. As a result, the frame can be attached to the holding member in an integrated structure. As a result, the external force can be reduced by the frame in a case where an external force is applied to the battery cell.
(3) In the above aspect (1), both end portions of the holding member may have a lid opening/closing portion that houses an end portion of the frame.

According to the aspect (3), the holding member has a lid opening/closing portion at both end portions, and the end portion of the frame is housed in the lid opening/closing portion. As a result, the frame can be attached to the holding member in an integrated structure. As a result, the external force can be reduced by the frame when an external force is applied to the battery cell.

(4) In the above aspect (1), the folded part may include a folded portion that is overlapped with the protruding portion, and the frame may be disposed in a space between the folded portion and the long side in the surface direction.

According to the aspect (4), the folded portion is provided in the folded part, and the folded portion is overlapped with the protruding portion. Further, the frame is disposed in the space between the folded portion and the long side. As a result, the frame can be disposed on the inner side of the folded part.

According to the above aspects (1) to (4), the electrode body can be protected from external forces.

### BRIEF DESCRIPTION OF THE DRAWINGS

FIG. 1 is a perspective view showing a battery cell according to a first embodiment of the present invention.

FIG. 2 is a perspective view showing a configuration of the battery cell in FIG. 1.

FIG. 3 is a cross-sectional view of the battery cell in FIG. 1, which is taken along the line III-III.

FIG. 4 is a perspective view showing a state in which a frame unit according to the first embodiment is connected to a positive electrode holding member and a negative electrode holding member.

FIG. 5 is an enlarged perspective view of a V portion in FIG. 4.

FIG. 6 is a perspective view showing a first support portion and a second support portion of the positive electrode holding member according to the first embodiment.

FIG. 7 is a perspective view showing a first lid opening/closing portion and a second lid opening/closing portion of a positive electrode holding member according to a second embodiment.

### DETAILED DESCRIPTION OF THE INVENTION

Hereinafter, a battery cell according to one embodiment of the present invention will be described with reference to the drawings.

### First Embodiment

### Battery Cell

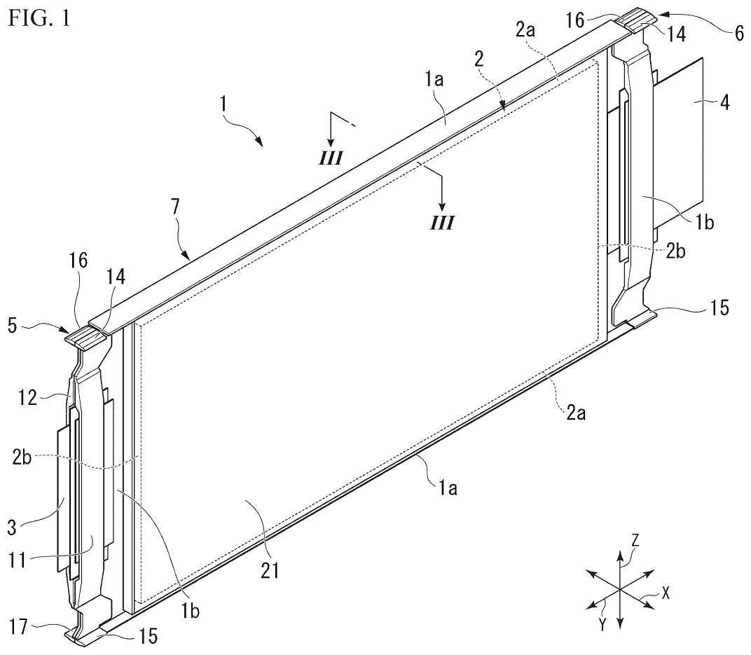

FIG. 1 is a perspective view showing a battery cell according to a first embodiment.

As shown in FIG. 1, a battery cell 1 is configured to be attachable and detachable from, for example, various power devices. Examples of the power devices to which the battery cell 1 is attached and detached include an electric vehicle, an electric mobile body, an electric machine, a power supply device, and various electrical instruments and the like. Examples of the electric vehicle include an electric automobile equipped with a rotating electrical machine driven by the power of battery cell 1, as a power source, a saddle-type vehicle and kick scooters, a hybrid vehicle obtained from a combination of a rotating electrical machine and an internal combustion engine, and a fuel cell vehicle and the like, which are obtained from a combination of the battery cell 1 and a fuel cell. Examples of the mobile body include a robot, a flying object, and mobile bodies on water or underwater. Examples of the electric machine include a construction machine and the like, which use a rotating electrical machine as a power source. The power supply device is, for example, a stationary or mobile power supply device that discharges and charges the battery cell 1.

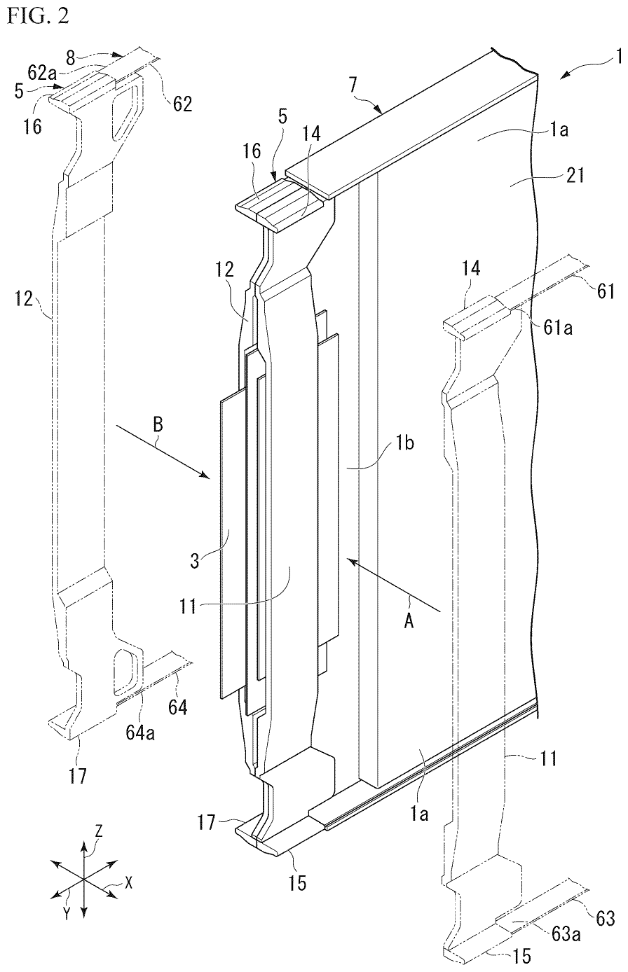

FIG. 2 is a perspective view showing a configuration of the battery cell in FIG. 1.

As shown in FIG. 1 to FIG. 3, the battery cell 1 is formed, for example, in a substantially rectangular shape, and has a pair of long sides la and a pair of short sides 1b. Hereinafter, descriptions may be made such that, among the surface directions of an exterior body 7 in the battery cell 1, the longitudinal direction of the pair of long sides 1a is referred to as the Y direction, and the lateral direction of the pair of short sides 1b is referred to as the Z direction.

The battery cell 1 includes an electrode body unit 2, a positive electrode tab (tab) 3, a negative electrode tab (tab) 4, a positive electrode holding member (holding member) 5, a negative electrode holding member (holding member) 6, an exterior body 7, and a frame unit (frame) 8.

### Electrode Body Unit

The electrode body unit 2 is formed, for example, in a substantially rectangular shape, and has a pair of long sides 2a and a pair of short sides 2b. The pair of long sides 2a are disposed along the pair of long sides la. The pair of short sides 2b are disposed along the pair of short sides 1b. The electrode body unit 2 is sealed in the exterior body 7 in a state in which the electrode body unit 2 is housed inside the exterior body 7, which will be described later. In the electrode body unit 2, a plurality of electrode bodies are stacked (not shown in the drawing). In the electrode body which is not shown in the drawing, for example, positive electrode layers, electrolyte layers, negative electrode layers, and the like are stacked a plurality of times in this order.

### Tab

The positive electrode tab 3 is provided on one short side 1b of the battery cell 1. The positive electrode tab 3 is a positive electrode lead connected to each of the positive electrodes of the plurality of electrode bodies through a current collecting tab (not shown in the drawing). The negative electrode tab 4 is provided on the other short side 1b of the battery cell 1. The negative electrode tab 4 is a negative electrode lead connected to each of the negative electrodes of the plurality of electrode bodies 20 through a current collecting tab (not shown in the drawing).

### Holding Member

The positive electrode holding member 5 includes, for example, a first member 11 and a second member 12. The positive electrode holding member 5 holds the positive electrode tab 3 by, for example, sandwiching the positive electrode tab 3 between the first member 11 and the second member 12. Hereinafter, a direction in which the first member 11 and the second member 12 sandwich the positive electrode tab 3 may be referred to as the “X direction.” The positive electrode holding member 5 is attached along a short side of the exterior body 7 which will be described below, in a state in which the positive electrode tab 3 is held by the first member 11 and the second member 12. The short side of the exterior body 7, which will be described later, is disposed along a short side 1b of the battery cell 1.

The first member 11 has first support portions 14 and 15 at both end portions in the Z direction. The first support portions 14 and 15 will be described in detail later.

The second member 12 has second support portions 16 and 17 at both end portions in the Z direction. The second support portions 16 and 17 will be described in detail later.

The negative electrode holding member 6 is, for example, a member symmetrical to the positive electrode holding member 5 in the Y direction. Hereinafter, the same reference numerals as those of the positive electrode holding member 5 are assigned to the respective members of the negative electrode holding member 6, and detailed explanations thereof will be omitted.

### Exterior Body

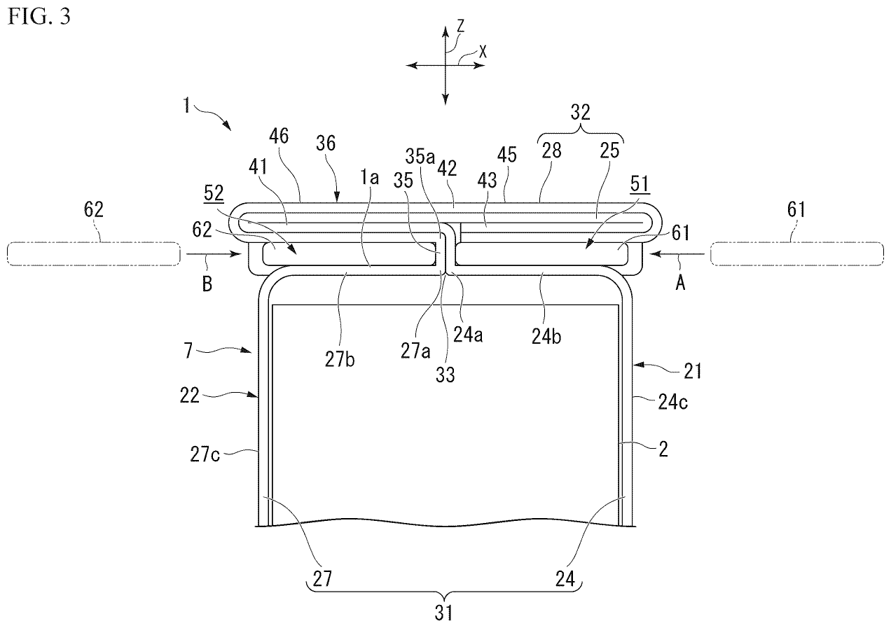

FIG. 3 is a cross-sectional view of the battery cell in FIG. 1, which is taken along the line III-III.

As shown in FIG. 1 and FIG. 3, the exterior body 7 includes a first laminate film (laminate film) 21 and a second laminate film (laminate film) 22.

The first laminate film 21 has a first recessed portion 24, a first connection portion 25, and a second connection portion (not shown in the drawings). The first recessed portion 24 is formed in a recessed shape that can house, for example, substantially one half of the electrode body unit 2 in the X direction. The first connection portion 25 is overhung outward from one portion of the opening portion 24a of the first recessed portion 24 in the Y direction to the outer side of the first recessed portion 24. The second connection portion, which is not shown in the drawing, is overhung outward from the other portion of the opening portion 24a of the first recessed portion 24 in the Y direction to the outer side of the first recessed portion 24. The second connection portion is a portion symmetrical to the first connection portion 25 in the Y direction. A detailed description of the second connection portion will be omitted below.

The second laminate film 22 has a second recessed portion 27, a first connection portion 28, and a second connection portion (not shown in the drawing). The second recessed portion 27 is formed in a recessed shape that can house, for example, substantially the other half part of the electrode body unit 2 in the X direction. The first connection portion 28 is overhung outward from one portion of the opening portion 27a of the second recessed portion 27 in the Y direction to the outer side of the second recessed portion 27. The second connection portion, which is not shown in the drawing, is overhung outward from the other portion of the opening portion 27a of the second recessed portion 27 in the Y direction to the outer side of the second recessed portion 27. The second connection portion is a portion symmetrical to the first connection portion in the Y direction. A detailed description of the second connection portion will be omitted below.

The first connection portion 25 of the first laminate film 21 and the first connection portion 28 of the second laminate film 22 are connected to each other. A housing portion 31, which houses the electrode body unit 2 with the first recessed portion 24 of the first laminate film 21 and the second recessed portion 27 of the second laminate film 22, is formed in the exterior body 7. That is, the electrode body unit 2 is covered with the housing portion 31 formed from the first recessed portion 24 of the first laminate film 21 and the second recessed portion 27 of the second laminate film 22. As a result, the electrode body unit 2 is sealed in the housing portion 31 by the first recessed portion 24 and the second recessed portion 27.

In a state of being connected to each other, the first connection portion 25 of the first laminate film 21 and the first connection portion 28 of the second laminate film 22 are formed in the folded part 32. That is, the exterior body 7 has the folded part 32 on the one long side la. The folded part 32 is provided from a boundary 33 between the first recessed portion 24 of the first laminate film 21 and the second recessed portion 27 of the second laminate film 22 to the outer side of the housing portion 31.

The folded part 32 includes a protruding portion 35 and a folded portion 36. The protruding portion 35 and the folded portion 36 are integrally formed by being bent or folded. The protruding portion 35 is provided at the boundary 33 between the first recessed portion 24 and the second recessed portion 27. The boundary 33 is located, for example, at the center of the exterior body 7 in the X direction. The protruding portion 35 protrudes outward, for example, from the boundary 33 in the surface direction of the exterior body 7 (specifically, the Z direction) to be orthogonal to the housing portion 31.

The folded portion 36 is integrally provided at a distal end 35a of the protruding portion 35. The folded portion 36 has a first folded section 41, a second folded section 42, and a third folded section 43. The first folded section 41 is folded in the X direction from the distal end 35a of the protruding portion 35 along a wall portion 27b of the second recessed portion 27 in the second laminate film 22. The first folded section 41 extends to a bottom portion 27c of the second recessed portion 27.

The second folded section 42 is folded in the X direction from the distal end of the first folded section 41 along the wall portion 24b of the first recessed portion 24 in the first laminate film 21 in a state in which the second folded section 42 is in contact with the first folded section 41. The second folded section 42 extends to a bottom portion 24c of the first recessed portion 24. The third folded section 43 is folded in the X direction from the distal end of the second folded section 42 along the wall portion 24b of the first recessed portion 24 in a state in which the third folded section 43 is in contact with the second folded section 42. The third folded section 43 extends to the distal end 35a of the protruding portion 35. The third folded section 43 is disposed to be flush with the first folded section 41.

That is, the folded portion 36 is provided to overlap the protruding portion 35. In this state, the folded portion 36 has a first folded portion 45 and a second folded portion 46. The first folded portion 45 extends in the X direction from the distal end 35a of the protruding portion 35 along the wall portion 24b of the first recessed portion 24 in the first laminate film 21. The first folded portion 45 is disposed to be spaced by a predetermined interval in the Y direction with respect to the wall portion 24b of the first recessed portion 24. A first space (space) 51 is formed between the first folded portion 45 and the wall portion 24b of the first recessed portion 24 (that is, on the long side 1a). The first space 51 is open to a side of the bottom portion 24c of the first recessed portion 24.

The second folded portion 46 extends in the X direction from the distal end 35a of the protruding portion 35 along the wall portion 27b of the second recessed portion 27 in the second laminate film 22. The second folded portion 46 is disposed to be spaced by a predetermined interval in the Y direction with respect to the wall portion 27b of the second recessed portion 27. A second space (space) 52 is formed between the second folded portion 46 and the wall portion 27b of the second recessed portion 27 (that is, on the long side 1a). The second space 52 is open to a side of the bottom portion 27c of the second recessed portion 27. The first space 51 and the second space 52 are formed on both sides of the protruding portion 35 in the X direction.

In addition, the exterior body 7 also has a folded part (not shown in the drawing) on the other long side 1a, in the same manner as on the one long side la. The folded part, which is not shown in the drawing, is formed in a state in which the second connection portion of the first laminate film 21 and the second connection portion of the second laminate film 22 are connected to each other.

In the embodiment, an example in which the folded part 32 is provided on the one long side la of the exterior body 7 and another folded part is provided on the other long side la will be described; however, the present invention is not limited thereto. As another example, the folded part 32 may be provided only on the other long side la of the exterior body 7. Alternatively, the folded part may be provided only on the other long side 1a of the exterior body 7. That is, it suffices that the exterior body 7 has a folded part on at least one long side la of the exterior body 7.

### Frame Unit

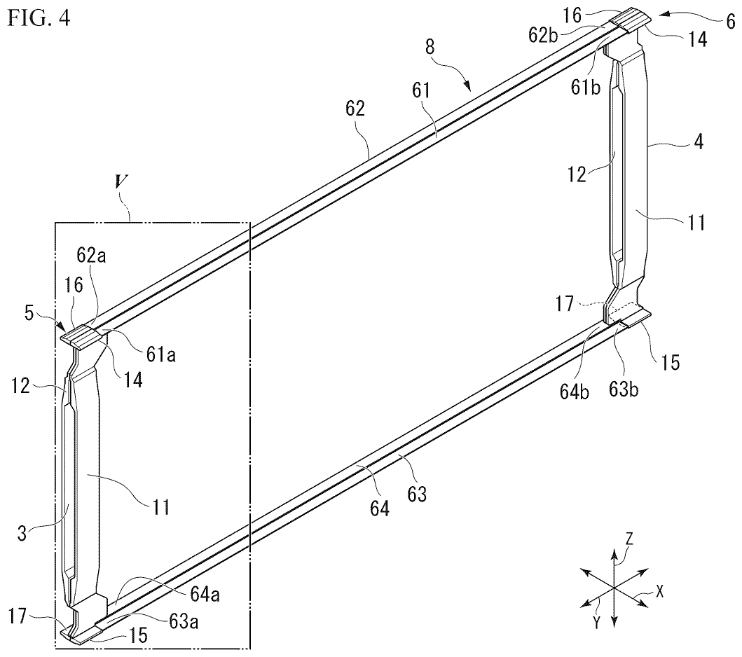

FIG. 4 is a perspective view showing a state in which a frame unit is connected to a positive electrode holding member and a negative electrode holding member.

As shown in FIG. 1, FIG. 2, and FIG. 4, the frame unit 8 is, for example, disposed on the pair of long sides 1a of the battery cell 1 and connected to the positive electrode holding member 5 and the negative electrode holding member 6. The frame unit 8 includes a first frame 61, a second frame 62, a third frame 63, and a fourth frame 64. The first frame 61 is formed in a plate shape of a substantially rectangular shape. Similar to the first frame 61, the second frame 62, the third frame 63, and the fourth frame 64 are also formed in a plate shape of a substantially rectangular shape.

As shown in FIG. 2 to FIG. 4, in the first member 11 of the positive electrode holding member 5, the first support portions 14 and 15 are provided at both ends in the Z direction. In addition, in the first member 11 of the negative electrode holding member 6, the first support portions 14 and 15 are provided at both ends in the Z direction. One end (end portion) 61a of the first frame 61 is connected to one of the first support portions 14 in the first member 11 of the positive electrode holding member 5. The other end (end portion) 61b of the first frame 61 is connected to one of the first support portions 14 in the first member 11 of the negative electrode holding member 6. The first frame 61 is disposed in the first space 51 from the opening toward the protruding portion 35 as indicated by an arrow A, in a state in which both ends 61a and 61b are connected to one of the first support portions 14 and 14, respectively.

A specific example, in which one end 61a of the first frame 61 is connected to one of the first support portions 14 in the first member 11 of the positive electrode holding member 5, will be described in detail later.

In addition, in the second member 12 of the positive electrode holding member 5, the second support portions 16 and 17 are provided at both ends in the Z direction. Further, in the second member 12 of the negative electrode holding member 6, the second support portions 16 and 17 are provided at both ends in the Z direction. One end (end portion) 62a of the second frame 62 is connected to one of the second support portions 16 in the second member 12 of the positive electrode holding member 5. The other end (end portion) 62b of the second frame 62 is connected to one of the second support portions 16 in the second member 12 of the negative electrode holding member 6. The second frame 62 is disposed in the second space 52 from the opening toward the protruding portion 35 as indicated by an arrow B, in a state in which both ends 62a and 62b are connected to one of the second support portions 16 and 16, respectively.

A specific example, in which one end 62a of the second frame 62 is connected to one of the second support portions 16 in the second member 12 of the positive electrode holding member 5, will be described in detail later.

In a state in which the first frame 61 is disposed in the first space 51 and the second frame 62 is disposed in the second space 52, the first frame 61 and the second frame 62 are disposed on both sides of the protruding portion 35 in the thickness direction (specifically, the X direction) of the exterior body 7. That is, the first frame 61 and the second frame 62 are provided on the one long side la of the exterior body 7.

As shown in FIG. 2 and FIG. 4, similar to one end 61a of the first frame 61, one end (end portion) 63a of the third frame 63 is connected to the other first support portion 15 in the first member 11 of the positive electrode holding member 5. Similar to the other end 61b of the first frame 61, the other end (end portion) 63b of the third frame 63 is connected to the other first support portion 15 in the first member 11 of the negative electrode holding member 6. Similar to the first frame 61, the third frame 63 is disposed in the first space (not shown in the drawing) from the opening toward each of the protruding portions (both not shown in the drawing) as indicated by the arrow A, in a state in which both ends 63a and 63b are connected to the other first support portions 15 and 15, respectively.

Similar to one end 62a of the second frame 62, one end (end portion) 64a of the fourth frame 64 is connected to the other second support portion 17 in the second member 12 of the positive electrode holding member 5. Similar to the other end 62b of the second frame 62, the other end (end portion) 64b of the fourth frame 64 is connected to the other second support portion 17 in the second member 12 of the negative electrode holding member 6. Similar to the second frame 62, the fourth frame 64 is disposed in the second space (not shown in the drawing) from the opening toward each of the protruding portions (both not shown in the drawing) as indicated by the arrow B, in a state in which both ends 64a and 64b are connected to the other second support portions 17 and 17, respectively.

As a result, similar to the first frame 61 and the second frame 62, the third frame 63 and the fourth frame 64 are disposed on both sides of the protruding portion (not shown in the drawing) in the thickness direction (X direction) of the exterior body 7. That is, the third frame 63 and the fourth frame 64 are provided on the other long side 1a of the exterior body 7.

In the embodiment, an example in which the first frame 61, the second frame 62, the third frame 63, and the fourth frame 64 are included as the frame unit 8 will be described; however, the present invention is not limited thereto. As another example, as the frame unit 8, for example, only the first frame 61 and the second frame 62 may be included, or only the third frame 63 and the fourth frame 64 may be included. That is, it suffices that the frame unit 8 is composed of a frame of at least two parts.

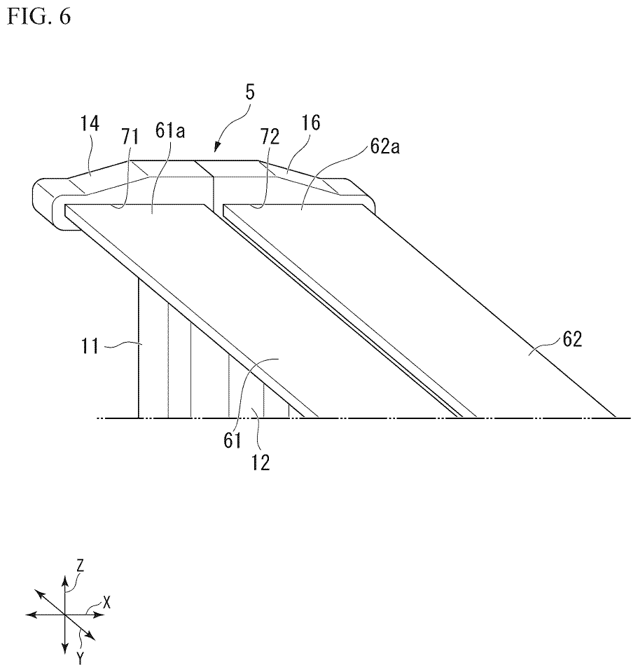

Next, a specific example in which the first frame 61 is connected to the positive electrode holding member 5, and a specific example in which the second frame 62 is connected to the positive electrode holding member 5 will be described with reference to FIG. 4 and FIG. 6.

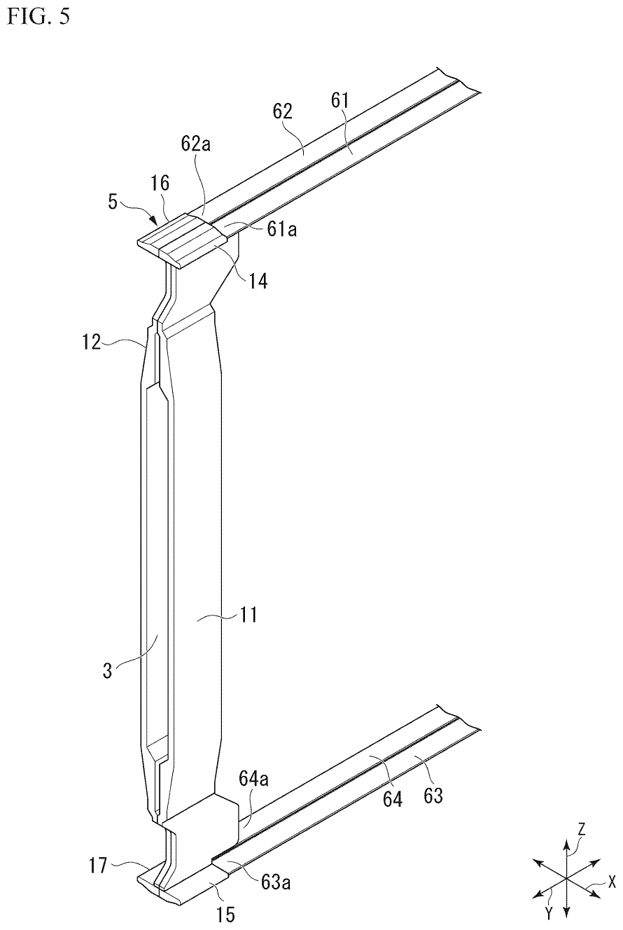

FIG. 5 is an enlarged perspective view of a V portion in FIG. 4. FIG. 6 is a perspective view showing a first support portion and a second support portion in the positive electrode holding member.

As shown in FIG. 5 and FIG. 6, a first opening portion (opening portion) 71 is open toward the Y direction in one of the first support portions 14 in the first member 11 of the positive electrode holding member 5. The first opening portion 71 may be penetrated toward the Y direction or may be formed to have a recessed shape. One end 61a of the first frame 61 is housed in the first opening portion 71, thereby being connected to one of the first support portions 14 in the first member 11.

As shown in FIG. 4, similar to one of the first support portions 14 in the positive electrode holding member 5, in one of the first support portions 14 in the first member 11 of the negative electrode holding member 6, the first opening portion 71 (not shown in the drawing) is open toward the Y direction. Similar to one end 61a of the first frame 61, the other end 61b of the first frame 61 is housed in the first opening portion 71 in the first member 11 of the negative electrode holding member 6, thereby being connected to the other first support portion 14.

As shown in FIG. 5 and FIG. 6, similar to one of the first support portions 14 in the first member 11, in one of the second support portions 16 in the second member 12 of the positive electrode holding member 5, the second opening portion (opening portion) 72 is open toward the Y direction. The second opening portion 72 may be penetrated toward the Y direction or may be formed to have a recessed shape. One end 62a of the second frame 62 is housed in the second opening portion 72, thereby being connected to one of the second support portions 16 of the second member 12.

As shown in FIG. 4, similar to one of the second support portions 16 in the positive electrode holding member 5, in one of the second support portions 16 in the second member 12 of the negative electrode holding member 6, the second opening portion 72 (not shown in the drawing) is open toward the Y direction. Similar to one end 62b of the second frame 62, the other end 62b of the second frame 62 is housed in the second opening portion 72 in the first member 11 of the negative electrode holding member 6, thereby being connected to the other second support portion 16.

Similar to one end 61 a and the other end 61b of the first frame 61, one end 63a and the other end 63b of the third frame 63 are also connected to the other first support portion 15 in the first member 11 of the positive electrode holding member 5, and the other first support portion 15 in the first member 11 of the negative electrode holding member 6, respectively.

In addition, similar to one end 62a and the other end 62b of the second frame 62, one end 64a and the other end 64b of the fourth frame 64 are also connected to the other second support portion 17 in the second member 12 of the positive electrode holding member 5, and the other second support portion 17 in the second member 12 of the negative electrode holding member 6.

According to the battery cell 1 according to the first embodiment described above, as shown in FIG. 2 to FIG. 4, the first frame 61, the second frame 62, the third frame 63, and the fourth frame 64 are provided on the pair of long sides 1a of the battery cell 1. In addition, the first frame 61, the second frame 62, the third frame 63, and the fourth frame 64 are connected to the positive electrode holding member 5 and the negative electrode holding member 6. Further, the folded part 32 of the exterior body 7 is provided on the pair of long sides 1a of the battery cell 1, and the protruding portion 35 provided in the folded part 32 protrudes in the Z direction of the exterior body 7. In addition, the first frame 61 and the second frame 62 are disposed on both sides of the protruding portion 35 that has protruded. In addition, the third frame 63 and the fourth frame 64 are disposed on both sides of the protruding portion that has protruded (not shown in the drawing).

As a result, the first frame 61, the second frame 62, the third frame 63, and the fourth frame 64 can be attached to the exterior body 7, the positive electrode holding member 5, and the negative electrode holding member 6 in an integrated structure. As a result, an external force can be reduced by the first frame 61, the second frame 62, the third frame 63, and the fourth frame 64 in a case where the external force is applied to the battery cell 1. Therefore, the electrode body (electrode body unit 2) sealed inside the exterior body 7 can be protected from external forces.

In addition, the first frame 61 and the second frame 62 are disposed on both sides (X direction sides) of the protruding portion 35, and the third frame 63 and the fourth frame 64 are disposed on both sides (X direction sides) of the protruding portion (not shown in the drawing). As a result, the first frame 61, the second frame 62, the third frame 63, and the fourth frame 64 can be prevented from protruding from the protruding portion 35 or the protruding portion (not shown in the drawing) in the surface direction of the exterior body 7 (specifically, in the Z direction).

In addition, as shown in FIG. 3, FIG. 4, and FIG. 6, a first opening portion 71 and a first opening portion are provided at both end portions of the positive electrode holding member 5, and the first opening portion 71 and the first opening portion (not shown in the drawing) are provided at both end portions of the negative electrode holding member 6. One end 61a of the first frame 61 and one end 63a of the third frame 63 are housed in the first opening portion 71 and the first opening portion at both end portions of the positive electrode holding member 5. In addition, the other end 61b of the first frame 61 and the other end 63b of the third frame 63 are housed in the first opening portion 71 and the first opening portion at both end portions of the negative electrode holding member 6.

In addition, a second opening portion 72 and a second opening portion are provided at both end portions of the positive electrode holding member 5, and the second opening portion 72 and the second opening portion (not shown in the drawing) are provided at both end portions of the negative electrode holding member 6. One end 62a of the second frame 62 and one end 64a of the fourth frame 64 are housed in the second opening portion 72 and the second opening portion at both end portions of the positive electrode holding member 5. In addition, the other end 62b of the second frame 62 and the other end 64b of the fourth frame 64 are housed in the second opening portion 72 and the second opening portion at both end portions of the negative electrode holding member 6.

As a result, the first frame 61, the second frame 62, the third frame 63, and the fourth frame 64 can be attached to the positive electrode holding member 5 and the negative electrode holding member 6 in an integrated structure. Additionally, an external force can be reduced by the first frame 61, the second frame 62, the third frame 63, and the fourth frame 64 in a case where the external force is applied to the battery cell 1.

In addition, as shown in FIG. 3, the folded portion 36 is provided in the folded part 32, and the folded portion 36 is overlapped with the protruding portion 35. Further, the first frame 61 and the second frame 62 are disposed in the first space 51 and the second space 52 between the folded portion 36 and the one long side la. Similar to the first frame 61 and the second frame 62, the third frame 63 and the fourth frame 64 are also disposed in the first space and the second space between the folded portion and the other long side 1a.

As a result, the first frame 61 and the second frame 62 can be disposed on the inner side of the folded part 32. Further, the third frame 63 and the fourth frame 64 can be disposed on the inner side of the folded part.

### Second Embodiment

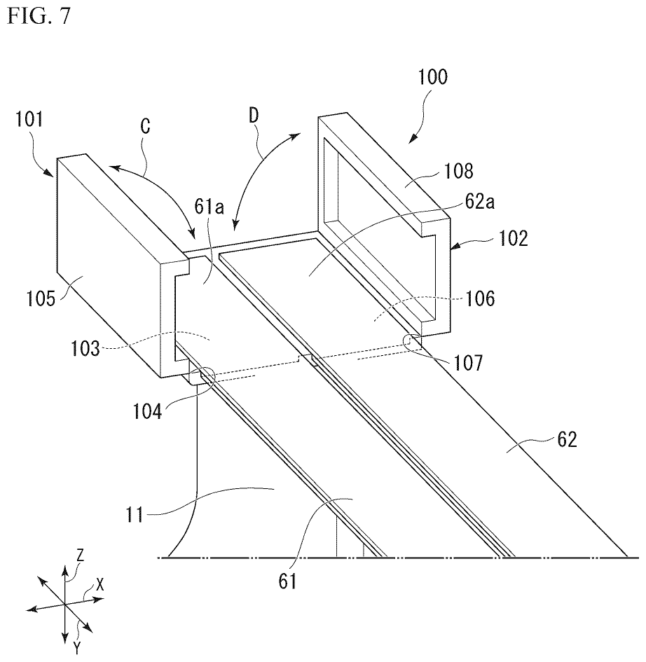

Next, a positive electrode holding member 100 and a negative electrode holding member (not shown in the drawing) according to a second embodiment will be described with reference to FIG. 7. It is noted that, in the second embodiment, the same reference numerals are assigned to the same or similar members as those in the first embodiment, and detailed descriptions thereof will be omitted.

FIG. 7 is a perspective view showing a first lid opening/closing portion and a second lid opening/closing portion of a positive electrode holding member according to the second embodiment.

As shown in FIG. 4 and FIG. 7, in the second embodiment, the positive electrode holding member 5 according to the first embodiment is replaced with the positive electrode holding member 100. In the positive electrode holding member 100, the first support portion 14 provided at one end of the first member 11 is replaced with a first lid opening/closing portion (lid opening/closing portion, lid opening/closing structure) 101, and the second support portion 16 provided at one end of the second member 12 is replaced with a second lid opening/closing portion (lid opening/closing portion, lid opening/closing structure) 102.

In addition, in the positive electrode holding member 100 according to the second embodiment, the first support portion 15 provided at the other end of the first member 11 is replaced with a first lid opening/closing portion (lid opening/closing portion, lid opening/closing structure) (not shown in the drawing). In addition, in the positive electrode holding member 100 according to the second embodiment, the second support portion 17 provided at the other end of the second member 12 is replaced with a second lid opening/closing portion (lid opening/closing portion, lid opening/closing structure) (not shown in the drawing). Other configurations of the positive electrode holding member 100 are the same as those of the positive electrode holding member 5 according to the first embodiment.

The first lid opening/closing portion 101 is provided at one end of the first member 11. The first lid opening/closing portion 101 has a first base 103, a first hinge 104, and a first lid portion 105. The first base 103 is provided at one end of the first member 11. The first lid portion 105 can be opened and closed as indicated by an arrow C through the first hinge 104.

The first lid portion 105 is closed on the first base 103 as indicated by the arrow C in a state in which one end 61a of the first frame 61 is disposed on the first base 103. One end 61a of the first frame 61 is sandwiched between the first base 103 and the first lid portion 105. As a result, one end 61a of the first frame 61 is connected to be in a state in which one end 61a of the first frame 61 is housed in the first lid opening/closing portion 101.

The first lid opening/closing portion provided at the other end of the first member 11 has the same configuration as the first lid opening/closing portion 101. As a result, the first lid opening/closing portion provided at the other end of the first member 11 is connected to be in a state in which the first lid opening/closing portion houses one end 63a of the third frame 63.

That is, both end portions of the first member 11 have the first lid opening/closing portion 101 that houses one end 61a of the first frame 61, and have the first lid opening/closing portion that houses one end 63a of the third frame 63.

The second lid opening/closing portion 102 is provided at one end of the second member 12. The second lid opening/closing portion 102 has a second base 106, a second hinge 107, and a second lid portion 108. The second base 106 is provided at one end of the second member 12. The second lid portion 108 can be opened and closed as indicated by an arrow D through the second hinge 107.

The second lid portion 108 is closed on the second base 106 as indicated by the arrow D in a state in which one end 62a of the second frame 62 is disposed on the second base 106. One end 62a of the second frame 62 is sandwiched between the second base 106 and the second lid portion 108. As a result, one end 62a of the second frame 62 is connected such that one end 62a of the first frame 62 is housed in the second lid opening/closing portion 102.

The second lid opening/closing portion provided at the other end of the second member 12 has the same configuration as the second lid opening/closing portion 102. As a result, the second lid opening/closing portion provided at the other end of the second member 12 is connected to be in a state in which the second lid opening/closing portion houses one end 64a of the fourth frame 64.

That is, both end portions of the second member 12 have the second lid opening/closing portion 102 that houses one end 62a of the second frame 62, and have the second lid opening/closing portion that houses one end 64a of the fourth frame 64.

In addition, in the second embodiment, the negative electrode holding member 6 according to the first embodiment is replaced with a negative electrode holding member (not shown in the drawing). Similar to the positive electrode holding member 100 according to the second embodiment, the negative electrode holding member according to the second embodiment has a first lid opening/closing portion 101 and a first lid opening/closing portion (not shown in the drawing) on both ends of the first member 11. That is, both end portions of the first member 11 have a first lid opening/closing portion 101 that is connected such that the other end 61b of the first frame 61 is housed and have a first lid opening/closing portion that is connected such that the other end 63b of the third frame 63 is housed.

In addition, similar to the positive electrode holding member 100 according to the second embodiment, the negative electrode holding member according to the second embodiment has a second lid opening/closing portion 102 and a second lid opening/closing portion (not shown in the drawing) on both ends of the second member. That is, both end portions of the second member 12 have a second lid opening/closing portion 102 that is connected to be in a state in which the other end 62b of the second frame 62 is housed, and have a second lid opening/closing portion that is connected to be in a state in which the other end 64b of the fourth frame 64 is housed.

According to the second embodiment described above, as shown in FIG. 4 and FIG. 7, the first lid opening/closing portion 101 and the first lid opening/closing portion are provided at both end portions of the positive electrode holding member 100, and the first lid opening/closing portion 101 and the first lid opening/closing portion are provided at both end portions of the negative electrode holding member. One end 61a of the first frame 61 and one end 63a of the third frame 63 are housed in the first lid opening/closing portion 101 and the first lid opening/closing portion at both end portions of the positive electrode holding member 100. In addition, the other end 61b of the first frame 61 and the other end 63b of the third frame 63 are housed in the first lid opening/closing portion 101 and the first lid opening/closing portion at both end portions of the negative electrode holding member.

In addition, the second lid opening/closing portion 102 and the second lid opening/closing portion are provided at both end portions of the positive electrode holding member 100, and the second lid opening/closing portion 102 and the second lid opening/closing portion are provided at both end portions of the negative electrode holding member. One end 62a of the second frame 62 and one end 64a of the fourth frame 64 are housed in the second lid opening/closing portion 102 and the second lid opening/closing portion at both end portions of the positive electrode holding member 100. In addition, the other end 62b of the second frame 62 and the other end 64b of the fourth frame 64 are housed in the second lid opening/closing portion 102 and the second lid opening/closing portion at both end portions of the negative electrode holding member.

As a result, the first frame 61, the second frame 62, the third frame 63, and the fourth frame 64 can be attached to the positive electrode holding member 100 and the negative electrode holding member in an integrated structure. As a result, an external force can be reduced by the first frame 61, the second frame 62, the third frame 63, and the fourth frame 64 in a case where the external force is applied to the battery cell 1.

It is noted that the technical scope of the present invention is not limited to the above-described embodiments, and various modifications can be made without departing from the gist of the present invention.

In addition, within the scope of the gist of the present invention, the constitutional elements in the above-described embodiments may be replaced with well-known constitutional elements as appropriate, and the above-described modified examples may be combined as appropriate.

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

Accordingly, the invention is not to be considered as being limited by the foregoing description, and is only limited by the scope of the appended claims.

### EXPLANATION OF REFERENCES

1 Battery cell
1a Long side
1b Short side
2 Electrode body unit
3 Positive electrode tab (tab)
4 Negative electrode tab (tab)
5 Positive electrode holding member (holding member)
6 Negative electrode holding member (holding member)
7 Exterior body
8 Frame unit (frame)
14, 15 First support portion
16, 17 Second support portion
21 First laminate film (laminate film)
22 Second laminate film (laminate film)
32 Folded part
35 Protruding portion
36 Folded portion
51 First space (space)
52 Second space (space)
61 First frame
61a One end (end portion) of first frame
61b Other end (end portion) of first frame
62 Second frame
62a One end (end portion) of second frame
62b Other end (end portion) of second frame
63 Third frame
63a One end (end portion) of third frame
63b Other end (end portion) of third frame
64 Fourth frame
64a One end (end portion) of fourth frame
64b Other end (end portion) of fourth frame
71 First opening portion (opening portion)
72 Second opening portion (opening portion)
101 First lid opening/closing portion (lid opening/closing portion)
102 Second lid opening/closing portion (lid opening/closing portion)

1. A battery cell having a substantially rectangular shape, the battery cell comprising:
a tab provided on a short side thereof;
a holding member that holds the tab;
an exterior body made of a laminate film having a folded part on at least one long side thereof; and
a frame disposed on the long side and connected to the holding member,
wherein the folded part includes a protruding portion that protrudes in a surface direction of the exterior body, and
the frame is composed of at least two parts and is disposed on both sides of the protruding portion in a thickness direction of the exterior body.

2. The battery cell according to claim 1,
wherein both end portions of the holding member have an opening portion that houses an end portion of the frame.

3. The battery cell according to claim 1,
wherein both end portions of the holding member have a lid opening/closing portion that houses an end portion of the frame.

4. The battery cell according to claim 1,
wherein the folded part includes a folded portion that is overlapped with the protruding portion, and
the frame is disposed in a space between the folded portion and the long side in the surface direction.
